(19) United States
(12) Patent Application Publication
(10) Pub. No.: US 2026/0012663 A1
(43) Pub. Date: Jan. 8, 2026

(54) SYSTEMS AND METHODS FOR DETECTING CHANNEL MEMBERSHIPS MENTIONS USING ARTIFICIAL INTELLIGENCE

(71) Applicant: Google LLC, Mountain View, CA (US)

(72) Inventors: Dhruv Bakshi, Zug (CH); Pedro Black, Pfäffikon (CH); Ludmila Danilescu, Zurich (CH)

(21) Appl. No.: 18/763,683

(22) Filed: Jul. 3, 2024

(51) Int. Cl. H04N 21/234; H04N 21/472

(52) U.S. Cl. CPC H04N 21/234; H04N 21/472

(57) ABSTRACT

A method includes identifying, by a processing device of a content sharing platform, a media item associated with a channel of the content sharing platform and data related to the media item. A prompt is provided as input to an artificial intelligence (AI) model, the prompt is to cause the AI model to identify, from the data related to the media item, one or more mentions of channel memberships associated with the channel. An output is received from the artificial intelligence (AI) model and an action is performed based on the output.

### TECHNICAL FIELD

The disclosed implementations relate to methods and systems for detecting channel memberships mentions using artificial intelligence.

### BACKGROUND

Content sharing platforms allow users to connect to and share information with each other. Many content sharing platforms include a content sharing aspect that allows users to upload, view, and share content, such as video items, image items, audio items, and so on. Other users of the content sharing platform can comment on the shared content, discover new content, locate updates, share content, and otherwise interact with the provided content. The shared content can include content from professional channel owners, e.g., movie clips, TV clips, and music video items, as well as content from amateur channel owners, e.g., video blogging and short original video items.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

An aspect of the disclosure provides a computer-implemented method which includes identifying, by a processing device of a content sharing platform, a media item associated with a channel of the content sharing platform and obtaining data related to the media item. A prompt is provided as input to an artificial intelligence (AI) model, the prompt is to cause the AI model to identify, from the data related to the media item, one or more mentions of channel memberships associated with the channel. An output is received from the artificial intelligence (AI) model and an action is performed based on the output.

A further aspect of the disclosure provides a system comprising: a memory; and a processing device, coupled to the memory, the processing device to perform a method according to any aspect or implementation described herein.

A further aspect of the disclosure provides a non-transitory computer-readable medium comprising instructions that, responsive to execution by a processing device, cause the processing device to perform operations according to any aspect or implementation described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of system architecture, in accordance with implementations of the disclosure.

FIG. 2 is an example graphical user interface (GUI) showing an example recommendation message on a channel owner's channel, in accordance with implementations of the disclosure.

FIG. 3 is an example GUI showing an example alert presented during a video, in accordance with implementations of the present disclosure, in accordance with implementations of the disclosure.

FIG. 4 depicts a flow diagram of an example method for identifying membership mentions in a media item, in accordance with implementations of the disclosure.

FIG. 5 depicts a block diagram of an example computing device operating in accordance with one or more aspects of the present disclosure.

### DETAILED DESCRIPTION

The content served by content sharing platforms can include video content, image content, audio content, text content, and so on (which may be collectively referred to as “media items”). Such media items can include audio clips, movie clips, TV clips, and music videos, as well as amateur content such as video blogging, short original videos, pictures, photos, other multimedia content, etc. In some content sharing platforms, channel owners can provide their content to other users via one or more personal channels (“channel”). A channel can be data content available from a common source or data content having a common topic, theme, or substance. The channel can serve as a homepage for the channel owner's account and include media items having a common topic, theme, or substance. The media items can be chosen, made available, and/or uploaded by the channel owner to the channel. The channel owner can further customize their channel(s) by selecting a background and color scheme, controlling some of the information that appears on the channel, etc.

Channel owners can enable certain content-related features to monetize their channel(s). For example, content creators can realize earnings from advertisements (“ads”) that would appear during certain segments of certain media items, receive revenue from viewers via a gratuity feature, sell merchandise, etc. In some instances, channel owners can generate revenue by enabling channel memberships that offer viewers (e.g., users of the content sharing platform) one or more particular tiers of content access (referred to as a “membership tier”). A membership tier is a feature of the content sharing platform that allows “members” to join a channel through monthly fees and receive members-only benefits also referred to as privileges. Each membership tier can have different privileges such as access to exclusive content (content not made available to non-members), badges, emojis, access to live-streams, chats and other bonus content that only members can access. In some instances, a particular channel can include multiple membership tiers, where each level can include different privileges for a different monthly fee.

One of primary drivers for obtaining new members is mentioning to viewers, during a video, that access to channel memberships is offered by the channel. However, many channel owners fail to mention or rarely mention that memberships are offered for their channel. In other instances where channel owners mention their channel memberships, many viewers may not fully comprehend the statement, or may fail to understand how to join a channel membership. This may cause channel owners and the content sharing platform to miss out on potential revenue.

Aspects and implementations of the present disclosure address the above and other deficiencies by providing a system for detecting when channel memberships are mentioned in channel owner videos. In instances where the system determines that channel memberships are not mentioned in the channel owner videos, the system can provide a recommendation for the channel owner. The recommendation can suggest that channel memberships be mentioned in the channel owner's videos to increase revenue. In instances where the system determines that channel memberships are mentioned in the channel owner's videos, the system can embed an action during the mention, such as, for example, emphasizing (e.g., highlighting, animating, etc.) a “join” button for joining a channel membership.

In some implementations, the system of the present disclosure can use an artificial intelligence model, such as a large language model (LLM) to determine when channel memberships are mentioned in a media item (e.g., in a video). A LLM is designed to understand and generate human-like text by analyzing and processing vast datasets of language from books, articles, and the internet. To determine when a channel owner mentions channel memberships in their videos, the present system can first generate audio transcription data (e.g., an audio transcript) from the video(s) (or from one or more segments of the video(s)). The audio transcription data can be generated using, for example, a text-embedding model, a speech recognition model, a speech-to-text model, etc. The present system can then generate an input prompt for the LLM. The input prompt can contain instructions for the LLM and serve to guide the output of the LLM. In particular, the input prompt can include context about channel memberships, the task assigned to the LLM (e.g., the type of data or analysis desired from the LLM), the data format in which to generate the output, and the related audio transcription data. The present system can then instruct the LLM to complete the assigned task (e.g., identify the number of times the channel owner mentioned channel memberships in the video) and generate output data reflecting the results. Using the output data obtained from the LLM, the present system can determine a course of action, such as, for example, whether to send the channel owner a recommendation to mention channel memberships more frequently, whether to embed triggers during specific portions of the video that emphasize a join button when the channel owner mentions channel memberships, etc. By encouraging the channel owners to mention channel memberships and/or emphasizing the join button, both the channel owners and the content sharing platform can earn additional revenue from viewers.

Aspects of the present disclosure result in improved performance of recommendation tools. In particular, the aspects of the present disclosure enable generating targeted recommendations for respective target channels and/or channel owners. As a result, the recommendations incentivize the channel owner to mention their channel memberships to their viewers and improve the conversion rate of new members. In addition, aspects of the present disclosure guide viewers towards the process of joining channel memberships during relevant portions of a video, thus also improving the conversions rate of new members.

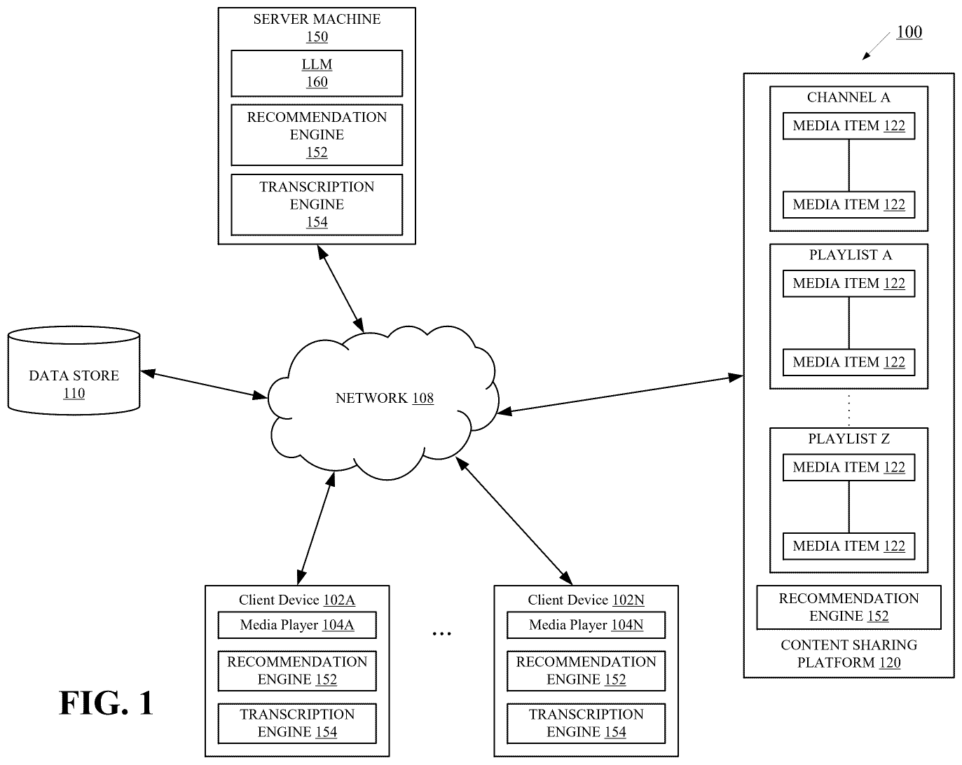

FIG. 1 illustrates an example system architecture 100, in accordance with implementations of the present disclosure. The system architecture 100 (also referred to as “system” herein) includes client devices 102A-102N, data store 110, content sharing platform 120, and/or server machine 150 each connected to a network 108. In some implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. Data store 110 can be hosted by one or more storage devices, such as main memory, magnetic or optical storage-based disks, tapes or hard drives, NAS, SAN, and so forth. In some implementations, data store 110 can be a network-attached file server, while in other implementations data store 110 can be some other type of persistent storage such as an object-oriented database, a relational database, and so forth, that may be hosted by application server 120 or one or more different machines (e.g., server machine 150, client device 102A-102N) coupled to the platform 120 via network 108.

Client devices 102A-102N can each include computing devices such as personal computers (PCs), laptops, mobile phones, smart phones, tablet computers, netbook computers, network-connected televisions, etc. In some implementations, client devices 102A-102N can also be referred to as “user devices.” In some implementations, each client device 102A-102N can include a media player 104A-104N. In some implementations, media player 104A-104N can be applications that allow users, such as channel owners, viewers, etc. to play back, view, or upload content, such as images, video items, web pages, documents, audio items, etc. For example, media players 104A-104N can be a web browser that can access, retrieve, present, or navigate content (e.g., web pages such as Hyper Text Markup Language (HTML) pages, digital media items, etc.) served by a web server. Media player 104A-104N can render, display, or present the content (e.g., a web page, a media viewer) to a user. In some implementations, media player 104A-104N can provide a user interface for presenting the media items and/or enabling user interaction with the media player 104A-104N. Media player 104A-104N can also include an embedded media player (e.g., a Flash® player or an HTML5 player) that is embedded in a web page (e.g., a web page that can provide information about a product sold by an online merchant). In another example, media players 104A-104N can be a standalone application (e.g., a mobile application, or native application) that allows users to playback digital media items (e.g., digital video items, digital images, electronic books, etc.). According to aspects of the present disclosure, media players 104A-104N can be a content sharing platform application for users to record, edit, and/or upload content for sharing on the content sharing platform. As such, media players 104A-104N can be provided to client devices 102A-102N by content sharing platform 120. For example, media players 104A-104N can be embedded media players that are embedded in web pages provided by the content sharing platform 120. In another example, media players 104A-104N can be applications that are downloaded from content sharing platform 120. In some implementations, the applications can include recommendation engine 152 and/or transcription engine 154.

In some implementations, content sharing platform 120 and server machine 150, can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that can be used to provide a user with access to media items or provide the media items to the user. Content sharing platform 120 can allow a user to consume, upload, search for, approve of (“like”), disapprove of (“dislike”), or comment on media items. Content sharing platform 120 can also include a website (e.g., a webpage) or application back-end software that can be used to provide a user with access to the media items.

In some implementations of the disclosure, a “user” can be represented as a single individual. However, other implementations of the disclosure encompass a “user” being an entity controlled by a set of users and/or an automated source. For example, a set of individual users federated as a community in a social network can be considered a “user”. In another example, an automated consumer can be an automated ingestion pipeline, such as a topic channel, of the content sharing platform 120. In some implementations, the user can access content on sharing platform 120 through a user account. The user can access (e.g., log in to) the user account by providing user account information (e.g., username and password) via an application on client device 110 (e.g., media player 104A-104N). In some implementations, the user account can be associated with a single user. In other implementations, the user account can be a shared account (e.g., family account shared by multiple users) (also referred to as “shared user account” herein). The shared account can have multiple user profiles, each associated with a different user. The multiple users can login to the shared account using the same account information or different account information. In some implementations, the multiple users of the shared account can be differentiated based on the different user profiles of the shared account.

In some implementations, an authorizing data service (also referred to as a “core data service” or “authorizing data source” herein) is a secure service that has access to data pertaining to user accounts on the content sharing platform 120 and that can use this data to decide whether to authorize a user account to obtain a requested content. In some implementations, the authorizing data service can authorize a user account (e.g., a client device associated with the user account) to access the requested content, authorize delivery of the requested content to the client device, or both. Authorization of the delivery of the content can involve authorizing how the content is delivered. In some implementations, the authorizing data service can use user account information to authorize the user account. In some implementations, an authentication token associated with client device 102A-102N or media player 104A-104N can be used to determine whether to authorize the user account and/or playback of requested content. In some implementations, the authorizing data service is part of content sharing platform 120. In other implementations, the authorizing data service can be an external service, such as a highly-secured authorizing service offered by a third-party.

In some implementations, content delivery platform 120 can use a content distribution network (CDN) (not shown) to stream the media items to one or more client devices 102A-102N for consumption by users. A CDN includes a geographically distributed network of servers that work together to provide fast delivery of content. The network of the servers can be geographically distributed to provide high availability and high performance by distributing content or services based, in some instances, on proximity to client devices 102A-102N. The closer a CDN server is to a client device 102A-102N, the faster the content can be delivered to the client device 102A-102N.

A media item can include an electronic file that can be executed or loaded using software, firmware or hardware configured to present the media item to a user. A media item 122 can include, and is not limited to, digital video, digital movies, digital photos, digital music, audio content, melodies, website content, social media updates, electronic books (ebooks), electronic magazines, digital newspapers, digital audio books, electronic journals, web blogs, real simple syndication (RSS) feeds, electronic comic books, software applications, etc. In some implementations, the media item 122 can be a live-stream media item. In some implementations, content sharing platform 120 can store the media items 122 using the data store 106, or can the media items (or and identifier of the media item) as electronic files in one or more formats using data store 106.

A video item is used as an example of a media item 122 throughout this disclosure. A video item is a set of sequential image frames representing a scene in motion. For example, a series of sequential image frames can be captured continuously or later reconstructed to produce animation. Video items can be presented in various formats including, but not limited to, analog, digital, two-dimensional and three-dimensional video. Further, video items can include movies, video clips or any set of animated images to be displayed in sequence. In addition, a video item (or media item) can be stored as a video file that includes a video component and an audio component. The video component can refer to video data in a video coding format or image coding format (e.g., H.264 (MPEG-4 AVC), H.264 MPEG-4 Part 2, Graphic Interchange Format (GIF), WebP, etc.). The audio component can refer to audio data in an audio coding format (e.g., advanced audio coding (AAC), MP3, etc.). It can be noted GIF can be saved as an image file (e.g., .gif file) or saved as a series of images into an animated GIF (e.g., GIF89a format). It can be noted that H.264 can be a video coding format that is a block-oriented motion-compensation-based video compression standard for recording, compression, or distribution of video content, for example.

In some implementations, the media item can be streamed, such as in a live-stream, to one or more of client devices 102A-102Z. It is be noted that “streamed” or “streaming” refers to a transmission or broadcast of content, such as a media item, where the received portions of the media item can be played back by a receiving device immediately upon receipt (within technological limitations) or while other portions of the media content are being delivered, and without the entire media item having been received by the receiving device. “Stream” can refer to content, such as a media item, that is streamed or streaming. A live-stream media item can refer to a live broadcast or transmission of a live event, where the media item is concurrently transmitted, at least in part, as the event occurs to a receiving device, and where the media item is not available in its entirety.

In some implementations, content sharing platform 120 can allow users to create, share, view or use playlists containing media items (e.g., playlist A-Z, containing media items 122). A playlist refers to a collection of media items that are configured to play one after another in a particular order without any user interaction. In some implementations, content sharing platform 120 can maintain the playlist on behalf of a user. In some implementations, the playlist feature of the content sharing platform 120 allows users to group their favorite media items together in a single location for playback. In some implementations, content sharing platform 120 can send a media item on a playlist to client device 102A-102N for playback or display. For example, media player 104A-104N can be used to play the media items on a playlist in the order in which the media items are listed on the playlist. In another example, a user can transition between media items on a playlist. In yet another example, a user can wait for the next media item on the playlist to play or can select a particular media item in the playlist for playback.

The content sharing platform 120 can include multiple channels (e.g., channels A through Z, of which only channel A is shown in FIG. 1) for providing media items from a common source or having a common topic, theme, or substance. Each channel can include one or more media items and can be managed by an owner (referred to as a “channel owner”), who is a user that can perform administrative actions on the channel. The administrative actions can include making media items available on the channel (e.g., choosing, uploading, and/or allowing presentation of the media items), enabling advertisements for the media items, enabling one or more membership tiers on the channel, etc. For example, a channel X (not shown) can include video media items Y and Z that were uploaded by the channel owner.

In some implementations, the channel owner can enable channel memberships that provide one or more membership tiers on a channel. Each membership tier can allow “members” to join the channel through monthly fees and receive privileges (e.g., members-only benefits) that can include access to exclusive content, badges, emojis, access to live-streams, chats, etc. In some implementations, a particular channel can offer multiple membership tiers, where each level can include different privileges for a different monthly fee.

In some implementations, content sharing platform 120 (and/or server machine 150 and/or client device 102A-102N) can include recommendation engine 152 that can generate recommendations to one or more users (e.g., channel owners, viewers, etc.) of content sharing platform 120. In some implementations, a recommendation can include an indicator (e.g., interface component such as, for example, a popup message, electronic message, recommendation feed, etc.) that provides a channel owner with personalized data related to mentioning, in their videos, a channel membership that offers viewers paid access to one or more membership tiers on a particular channel. In some implementations, the recommendation(s) can be presented on media player 104A-104N (e.g., on the user interface associated with a channel of a channel owner), sent to a different application associated with the channel owner (e.g., sent as an email message to an email address related to the channel creator, sent as a text to a phone number related to the channel creator, etc.) and/or provided to the channel owner using other means.

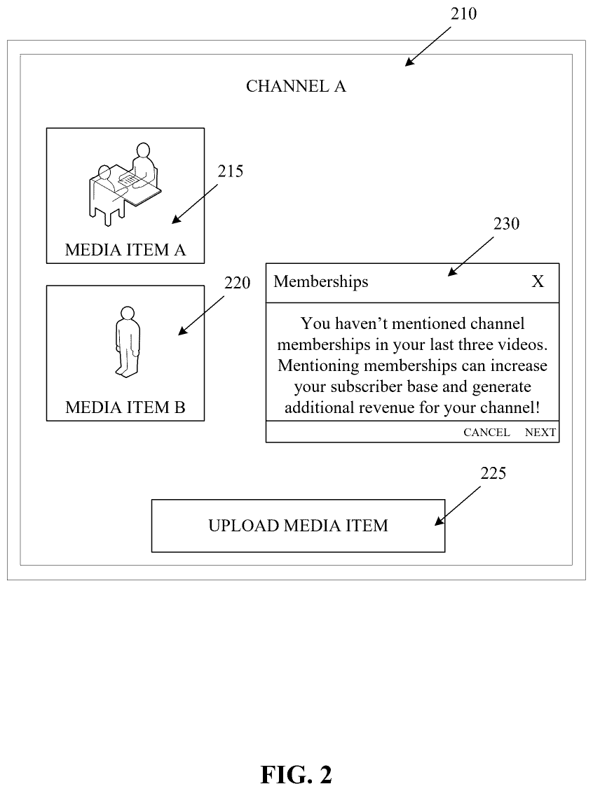

FIG. 2 is an example graphical user interface (GUI) showing an example recommendation message on a channel owner's channel, in accordance with implementations of the present disclosure. In particular, FIG. 2 shows GUI 210 which presents a channel owner's channel (e.g., channel A). Channel A includes two media items (media item A 215 and media item B 220) uploaded to channel A by the channel owner. Button 225 allows the channel owner to upload additional media items. Recommendation message 230 is a pop-up window displayed on GUI 210. Recommendation message 230 includes a message to the channel owner, that was generated by recommendation engine 152, which indicates that channel memberships have not been mentioned in the channel owners' last three videos, and that mentioning memberships can increase the channel owner's subscriber base and generate additional revenue for their channel.

Returning to FIG. 1, in some implementations, a recommendation can include an alert to the viewer. The alert can include a visual cue to a viewer recommending that they obtain a membership. For example, when recommendation engine 152 determines that a channel membership has been mentioned in the channel owner's video, recommendation engine 152 can embed a trigger during that specific position in the video to generate a message (e.g., a popup) on the video recommending that the viewer obtain a channel membership, emphasizing a button (e.g., a join button) related to obtaining a channel membership, etc. Emphasizing the button can include highlighting the button, animating the button by changing the size of the button, changing the location of the button, tilting the button, generating animations near the button (e.g., generate sparkle animations, fireworks animations, confetti animations, etc.), and so forth.

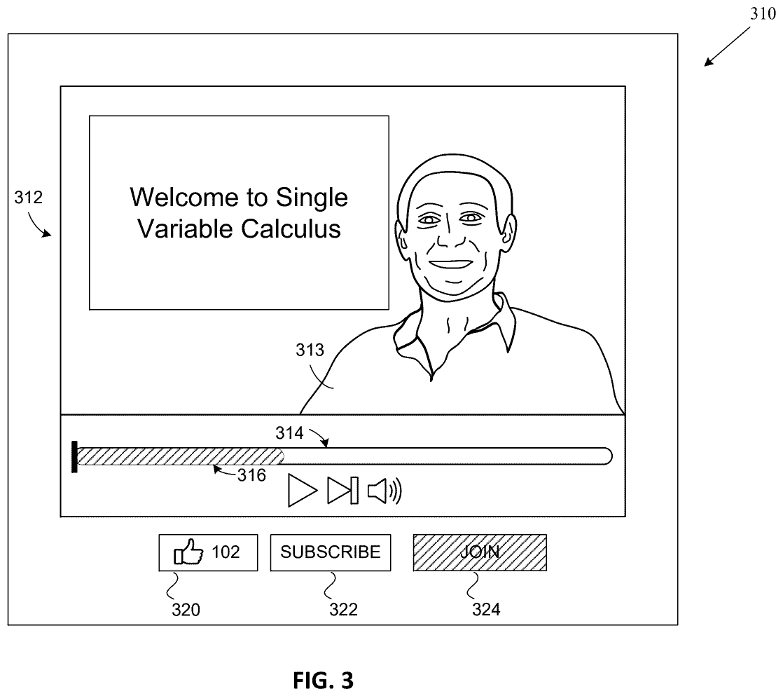

FIG. 3 is an example GUI showing an example alert presented during a video, in accordance with implementations of the present disclosure. In particular, FIG. 3 shows GUI 310 which includes media item 312 (e.g., a video relating to a calculus lecture), payback bar 324 (a timeline related to media item 312 that corresponds to a length of a playback of media item 312), a UI clement 326 that indicate a progress of the playback of media item 312. GUI 310 further includes UI clement 320 that enable the user to endorse (e.g., “like”) media item 312, UI element 322 that enables the user to subscribe to a channel related to media item 312, and UI clement 324 that enables the user to obtain a channel membership (e.g., “join”) related to media item 312. In response to detecting that the video mentions memberships (e.g., via presenter 313, an overlaid voice, etc.), recommendation engine 152 can generate an alert. In the illustrative example shown, recommendation engine 152 highlights join button 324. In other implementations, recommendation engine 152 can animate join button 324, generate animations near join button 324, etc. These alerts can be embedded in the video by recommendation engine 152 and can trigger (for a predetermined duration, during the entirety of the mention, etc.) in response to channel memberships being mentioned during playback of media item 312. Alternatively, alerts can be added to media item 312 by a client application when the media item 312 is created to upload to content sharing platform 120. Yet alternatively, any other component of server 150 and/or content sharing platform 120 can add alerts to media item 312.

Returning to FIG. 1, in some implementations, the recommendations or alerts can be generated or embedded using data obtained from LLM 160. An LLM is a type of artificial intelligence (e.g., machine learning) model designed to understand and generate human-like text. In particular, LLM 160 can perform natural language processing tasks such as language translation, text summarization, question answering, etc. LLM 160 can be built on deep learning architectures, such as transformer models. In some implementations, LLM 160 can be generated through supervised learning, during which LLM 160 is trained on large datasets of text. The text can be gathered from various sources, such as books, articles, websites, etc.

In some implementations, a text dataset can be used to pre-train LLM 160 on a language modeling task where LLM 160 learns to predict the next word in a sequence of text given the previous words. This pre-training phase can be used to develop, for LLM 160, a deep understanding of language patterns and semantics. After pre-training, LLM 160 can be fine-tuned on specific tasks to specialize its capabilities. During fine-tuning, LLM 160 can be exposed to examples of the target task, such as text classification or language translation, corresponding labels or target outputs, etc. In some implementations, LLM 160 can adjust one or more parameters to minimize the difference between predictions and true outputs. The adjusting can be performed using iterative optimization techniques, such as, for example, gradient descent. The adjusting process can enable LLM 160 to adapt pre-learned knowledge to the nuances of the target task, making it more effective in real-world applications. In some implementations, LLM 160 can be used to understand when channel owners (or any other speech in a media item) mentions a channel membership. This will be described in detail below.

In some implementations, in order to generate memberships recommendations and/or alerts, recommendation engine 152 can use, as input for LLM 160, data relating to one or more audio related features (e.g., audio transcription data). Audio transcription data can include a transcription of the audio data from a segment of a media item (e.g., from a video) or from the entirety of the media item. In some implementations, transcription engine 154 can generate the audio transcription data using a text extractor system (e.g., software, an algorithm, etc.). For example, transcription engine 154 can convert audio data corresponding to a media item (or corresponding to one or more segments of the media item) into text data. Examples of the text extractor system can include a text-embedding model (e.g., the universal sentence embedding model), a speech recognition model, a speech-to-text model, etc. In some implementations, the audio transcription data can be generated by user input. For example, a user (e.g., a channel owner) can generate a transcript of the audio corresponding to one or more segments of a media item and/or to one or more media items. The transcript can be included, for example, as metadata related to the media item. In some implementations, the audio transcription data can be generated using an optical character recognition (OCR) system. An OCR system can include a software tool that converts visual data (e.g., images, frames, etc.) into editable and searchable text. In one example, an OCR system can generate text data from closed captions or subtitles associated with a media item 122 (e.g., if such closed captions or subtitles associated with the media item 122 are not otherwise available).

Recommendation engine 152 can instruct LLM 160 to perform one or more tasks. A task can refer to the type of data or analysis desired from LLM 160. The tasks can include, for example, identifying instances of channel memberships being mentioned, classifying the type of mention identified, using a particular format for generating output data, etc.

An instance of a channel membership being mentioned can include any instance of the where channel memberships are discussed, referred to, advertised, or in any way referenced.

Classifying the type of mention identified can include correlating a mention with a certain category. The categories can include, for example, a promotional category where channel owners encourage viewers to join the channel memberships (e.g., please join my channel), a gratitude category where channel owners thank existing members (e.g., thank you members for your commitment to my channel), a benefits category where channel owners discuss the perks related to one or more tiers of their channel memberships (e.g., join channel A will give you exclusive content), and so forth.

The output format can reflect how the LLM 160 is to provide the data it was tasked to obtain. In some implementations, the output format can instruct LLM 160 to provide timestamp data related to each identified mention (e.g., during which time period of the media item was a memberships mention identified), to label each mention based on a category, etc. In some implementations, the output format can instruct LLM 160 as to which file format to use when providing the output data (e.g., present the data in JavaScript Object Notation (JSON) format, YAML Ain't Markup Language (YMAL), etc.).

Recommendation engine 152 can then obtain, as output from LLM 160, data reflecting the channel membership mentions, the type of channel membership mentioned, etc. In some instances, the output data can be in the format requested by recommendation engine 152. Recommendation engine 152 can then determine, based on the output data, one or more actions to perform, such as, for example, sending a recommendation to the channel owner, generating an alert during a specific segment of a media item, etc. In some implementations, recommendation engine 152 can determine the action to perform by determining whether the output data satisfies one or more criteria. In one illustrative example, in response to determining that the number of mentions in one or more media items is below a threshold value (e.g., below two mentions per video, below three mentions in two or more videos, etc.), recommendation engine 152 can send a recommendation to the channel owner. In another illustrative example, in response to identifying a mention in a media item, recommendation engine 152 can embed a trigger that will emphasize the join button in UI when the media item plays the mention. This allows the join button to be emphasized during playback of the media item. In some implementations, the action can include recommendation engine 152 storing the output data in data store 110.

In some implementations, a media item can be a live-streamed media item. During such implementations, recommendation engine 152 can generate audio transcription data during the live stream (e.g., every second, continuously feed the live stream into a text-embedding model, obtain auto-generated closed captions, etc.) and continuously instruct LLM 160 to generate output data (e.g., generate output data every second, every two seconds, etc.). In response to the output data indicating that a membership mention occurred during the live-stream, recommendation engine 152 can, for example, emphasize the join button. The join button can be emphasized for a predetermined time (e.g., for a certain amount of seconds), until the LLM indicates that the memberships mention is over, etc.

In some implementations, other AI models can be used in place or in addition to LLM 160, such as deep networks. An example of a deep network is a neural network with one or more hidden layers, and such an AI model can be trained by, for example, adjusting weights of a neural network in accordance with a backpropagation learning algorithm or the like. In other or similar implementations, the AI model can be created by finding patterns in training data, identifying clusters of data that correspond to the identified patterns, and providing the AI models that capture these patterns. Some AI models can use one or more of support vector machine (SVM), Radial Basis Function (RBF), clustering, supervised machine learning, semi-supervised machine learning, unsupervised machine learning, k-nearest neighbor algorithm (k-NN), linear regression, multi-linear regression, non-linear regression, random forest, gradient-boosted trees, neural network (e.g., artificial neural network), etc.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

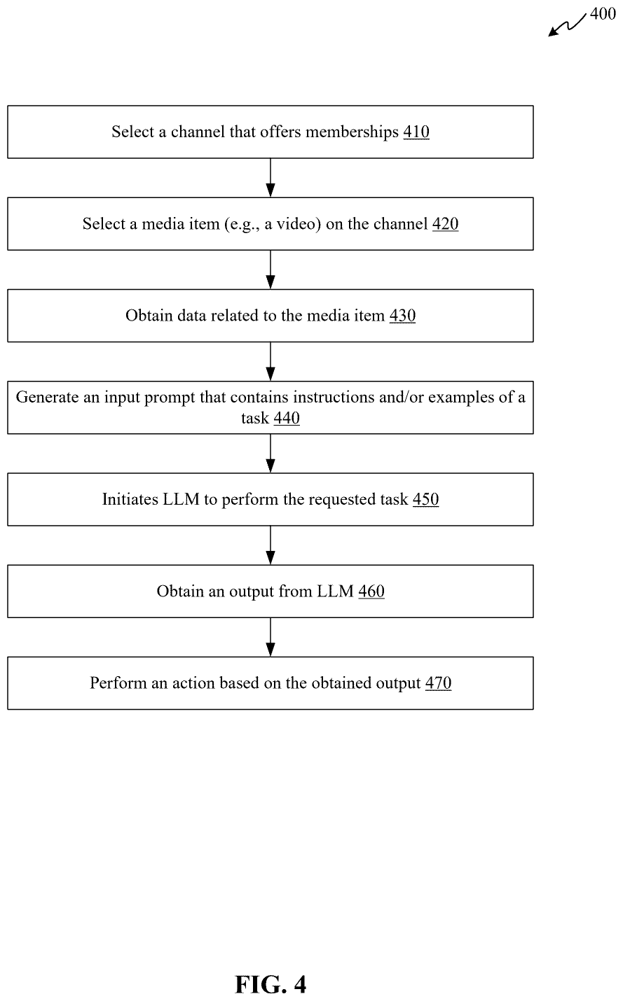

FIG. 4 depicts a flow diagram of an example method 400 for identifying membership mentions in a media item, in accordance with implementations of the present disclosure. Method 400 can be performed by processing logic that can include hardware (circuitry, dedicated logic, etc.), software (e.g., instructions run on a processing device), or a combination thereof. In one implementation, some or all of the operations of method 400 can be performed by one or more components of system 100 of FIG. 1. In some implementations, some or all of the operations of method 400 can be performed by recommendation engine 152, as described above.

For simplicity of explanation, method 400, as well as any other method of this disclosure, is depicted and described as a series of acts. However, acts in accordance with this disclosure can occur in various orders and/or concurrently, and with other acts not presented and described herein. Furthermore, not all illustrated acts may be required to implement method 400 in accordance with the disclosed subject matter. In addition, those skilled in the art will understand and appreciate that method 400 could alternatively be represented as a series of interrelated states via a state diagram or events. Additionally, it should be appreciated that method 400 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At operation 410, processing logic selects a channel that offers memberships. The channel can be selected at random, based on a predetermined criterion (e.g., age of the channel, geographic region of the channel, type of channel, channel owner input, etc.). In some instances, the processing logic can select a channel and then determine whether the channel offers memberships (e.g., offers at least one membership tier). Responsive to the processing logic determining that the channel does not offer memberships, the processing logic can select another channel.

At operation 420, processing logic selects a media item (e.g., a video) on the channel.

At operation 430, processing logic obtains data related to the media item. The data related to the media item can be audio transcription data that includes a transcription of the audio data from a segment of a media item or from the entirety of the media item. In some implementations, the processing logic can obtain the audio transcription data using, for example, a text extractor system (e.g., a text-embedding model, a speech recognition model, a speech-to-text model, etc.). In some implementations, the processing logic can generate the audio transcription data from closed captions or subtitles associated with a media item. Alternatively, the data related to the media item can be the media item itself.

At operation 440, processing logic generates an input prompt that contains instructions and/or examples of a task. The input prompt can serve to guide the output of LLM 160.

In some implementations, the input prompt can include content instructions. Content instructions can be used to inform an LLM (e.g., LLM 160) about the type of conversation LLM 160 is engaging in and/or the function LLM 160 is to perform. The context instructions can be used to aid LLM 160 in avoiding lengthy replies, consistently generating readable text, expediting operations, etc. In an illustrative example, context instruction can include the following prompt:
Channel memberships are a feature on a content sharing platform that allows viewers to financially support their favorite channel owners by paying a monthly fee. In exchange for their support, members get access to exclusive perks and benefits.
In another illustrative example, context instructions can include the following prompt: What are channel memberships? Channel memberships allow content sharing platform creators to offer special perks to their viewers in exchange for a monthly fee. These viewers are called Members. Some typical perks that creators offer are: members-only badges and emoji, exclusive content, discounted merchandise, and early access to videos. Creators can set up different membership tiers with different price points, where the highest tiers are more expensive and hence have access to a wider range of exclusive perks.

In some implementations, the input prompt can include task instructions. Task instructions can be used to identify the type of data or analysis desired from LLM 160. In an illustrative example, task instructions can include the following prompt:
Carefully consider if the transcript text below mentions the channel memberships program. Focus specifically on channel memberships, not similar programs such as program A. Think about indirect references to membership features or benefits, but be mindful of similar language that might not specifically relate to channel memberships.
In another illustrative example, task instructions can include the following prompt: In order to advertise their Channel Memberships offering, creators use their videos to ask their viewers to buy memberships to their channel. Pretend you are a fan of a channel, and you want to support them. I will show you the transcript of a video. Find any mentions to Channel Memberships.

In some implementations, the task instructions can further include supplemental task instructions such as, for example, classification instructions, timestamp instructions, etc. time stamp instructions can request that LLM 160 identify each portion of the content item where a channel membership mention is identified. Classification instructions can request LLM 160 to classify mentions of channel memberships into two or more defined categories. In an illustrative example, supplemental task instructions can include the following prompt:
Classify the mentions into one of these categories:
   PROMOTIONAL: Creators encouraging viewers to join.
   GRATITUDE: Creators thanking existing members.
   BENEFITS: Discussion of membership perks.

In some implementations, the input prompt can include a desired output format. The output format can reflect how LLM 160 is to structure the output data. For example, the input prompt can request that LLM 160 provide the results in a valid JSON (JavaScript Object Notation) format.

In some implementations, the input prompt can include one or more examples. The examples can provide additional context to LLM 160, such as, for example, how LLM 160 should answer. In particular, the examples can illustrate to LLM 160 the type of data desired, the type of format desired, etc.

In some implementations, the input prompt can include distinction data. The distinction data can be used to instruct LLM 160 of non-desired answers. In an illustrative example, distinction data can state to LLM 160 to “not confuse mentions of Channel Memberships in the video transcript with mentions of other off-platform ways of supporting the creator.”

In some implementations, the input prompt can include the data (e.g., audio transcription data or the media item itself) obtained at operation 430.

At operation 450, processing logic provides a prompt as input to LLM 160. For example, processing logic 450 provides the input prompt including content described above and instructions to the LLM to perform the requested task.

At operation 460, processing logic obtains an output from LLM 160. The output can reflect the results generated by LLM 160 from performing the requested task. In some implementations, the output can be in the format that LLM 160 was requested to use.

At operation 470, processing logic performs an action based on the obtained output. In some implementations, such as those where the number of channel membership mentions satisfies a predetermined criterion (e.g., the number of mentions is below a certain threshold value), the action can include sending a recommendation to the channel owner. For example, in response to determining that the number of mentions in the media item is below two, the processing logic can send a recommendation to the channel owner advising them that mentioning channel memberships at least twice in a video can increase the conversion rate of viewers to members.

In some implementations, for each mention detected in the media item, processing logic can embed a trigger during each position of the media item that mentions channel memberships. The trigger can emphasize the join button or generate a message (e.g., a popup) when the viewer watches the portion of the media item where channel memberships are mentioned.

In implementations where segments of the media item are used, one or more of operations 430-470 can be performed for one or more other segments of the media item.

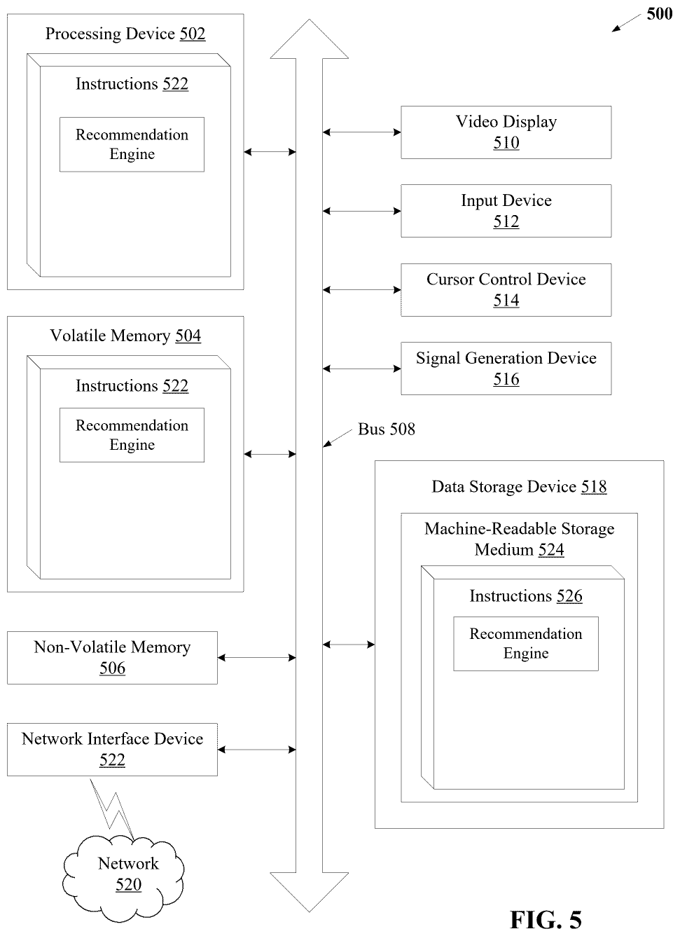

FIG. 5 depicts a block diagram of a computer system operating in accordance with one or more aspects of the present disclosure. In certain implementations, computer system 500 can be connected (e.g., via a network, such as a Local Area Network (LAN), an intranet, an extranet, or the Internet) to other computer systems. Computer system 500 can operate in the capacity of a client device. Computer system 500 can operate in the capacity of a server or a client computer in a client-server environment. Computer system 500 can be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 can include a processing device 502, a volatile memory 504 (e.g., random access memory (RAM)), a non-volatile memory 506 (e.g., read-only memory (ROM) or electrically erasable programmable ROM (EEPROM)), and a data storage device 518, which can communicate with each other via a bus 508.

Processing device 502 can be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 500 can further include a network interface device 522. Computer system 500 also can include a video display unit 510 (e.g., an LCD), an input device 512 (e.g., a keyboard, an alphanumeric keyboard, a motion sensing input device, touch screen), a cursor control device 514 (e.g., a mouse), and a signal generation device 516.

Data storage device 518 can include a non-transitory machine-readable storage medium 524 on which can store instructions 526 encoding any one or more of the methods or functions described herein, including instructions encoding components of client device of FIG. 1 for implementing method 400.

Instructions 526 can also reside, completely or partially, within volatile memory 504 and/or within processing device 502 during execution thereof by computer system 500, hence, volatile memory 504 and processing device 502 can also constitute machine-readable storage media.

While machine-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “determining,” “sending,” “displaying,” “identifying,” “selecting,” “excluding,” “creating,” “adding,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can comprise a general-purpose computer system selectively programmed by a computer program stored in the computer system. Such a computer program can be stored in a computer-readable tangible storage medium.

The methods and illustrative examples described herein are not inherently related to any particular computer or other apparatus. Various general-purpose systems can be used in accordance with the teachings described herein, or it can prove convenient to construct more specialized apparatus to perform method 400 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
identifying, by a processing device of a content sharing platform, a media item associated with a channel of the content sharing platform;
obtaining data related to the media item;
providing, as input to an artificial intelligence (AI) model, a prompt to cause the AI model to identify, from the data related to the media item, one or more mentions of channel memberships associated with the channel;
receiving an output from the artificial intelligence (AI) model; and
performing an action based on the output.

2. The method of claim 1, wherein the action comprises:
generating a recommendation reflecting enabling channel memberships on the channel; and
providing, for a channel owner of the channel, an indicator referencing the recommendation.

3. The method of claim 2, wherein the indicator is at least one of a pop-up message on a user interface associated with the channel, an email message, or a text message.

4. The method of claim 1, wherein the action comprises embedding, in the media item, a trigger to emphasis, during one or more portions of the media item, a button associated with channel memberships.

5. The method of claim 1, wherein the output classifies each identified mention into one or more categories.

6. The method of claim 1, wherein the output includes a timestamp of each identified mention.

7. The method of claim 1, wherein the prompt includes a type of format to structure the output.

8. The method of claim 1, wherein the data related to the media item is an audio transcription of the media item.

9. A system comprising:
a memory; and
a processing device, coupled to the memory, the processing device to perform operations comprising:
identifying a media item associated with a channel of a content sharing platform;
obtaining data related to the media item;
providing, as input to an artificial intelligence (AI) model, a prompt to cause the AI model to identify, from the data related to the media item, one or more mentions of channel memberships associated with the channel;
receiving an output from the artificial intelligence (AI) model; and
performing an action based on the output.

10. The system of claim 9, wherein the action comprises performing operations comprising:
generating a recommendation reflecting enabling channel memberships on the channel; and
providing, for a channel owner of the channel, an indicator referencing the recommendation.

11. The system of claim 10, wherein the indicator is at least one of a pop-up message on a user interface associated with the channel, an email message, or a text message.

12. The system of claim 9, wherein the action comprises embedding, in the media item, a trigger to emphasis, during one or more portions of the media item, a button associated with channel memberships.

13. The system of claim 9, wherein the output classifies each identified mention into one or more categories.

14. The system of claim 9, wherein the output includes a timestamp of each identified mention.

15. The system of claim 9, wherein the prompt includes a type of format to structure the output.

16. The system of claim 9, wherein the data related to the media item is an audio transcription of the media item.

17. A non-transitory computer-readable medium comprising instructions that, responsive to execution by a processing device, cause the processing device to perform operations comprising:
identifying a media item associated with a channel of a content sharing platform;
obtaining data related to the media item;
providing, as input to an artificial intelligence (AI) model, a prompt to cause the AI model to identify, from the data related to the media item, one or more mentions of channel memberships associated with the channel;
receiving an output from the artificial intelligence (AI) model; and
performing an action based on the output.

18. The non-transitory computer readable storage medium of claim 17, wherein the action comprises performing operations comprising:
generating a recommendation reflecting enabling channel memberships on the channel; and
providing, for a channel owner of the channel, an indicator referencing the recommendation.

19. The non-transitory computer readable storage medium of claim 17, wherein the action comprises embedding, in the media item, a trigger to emphasis, during one or more portions of the media item, a button associated with channel memberships.

20. The non-transitory computer readable storage medium of claim 17, wherein the output classifies each identified mention into one or more categories.
